(19) United States
(12) Patent Application Publication
(10) Pub. No.: US 2017/0169135 A1
(43) Pub. Date: Jun. 15, 2017

(54) Replication of Components Through Geometric Element Matching

(71) Applicant: Onshape Inc., Cambridge, MA (US)

(72) Inventors: Malay Kumar, Acton, MA (US); Abraham K. Feldman, Somerville, MA (US)

(21) Appl. No.: 15/373,564

(22) Filed: Dec. 9, 2016

Related U.S. Application Data
(60) Provisional application No. 62/266,231, filed on Dec. 11, 2015.

(51) Int. Cl. G06F 17/50; G06T 7/13; G06T 7/60

(52) U.S. Cl. CPC G06F 17/50; G06T 7/60; G06T 7/13; G06T 2207/20101; G06F 3/0482

(57) ABSTRACT

A replication method for use within CAD software ignores parametric requirements and instead searches 3D geometry of components mated to a replication candidate directly for geometric elements that are identical to those on which the candidate is constrained. The system counts the number of identical geometric elements to determine the number of candidate instances to replicate, and then constrains one instance to each element with constraints equivalent to the constraints applying to the original candidate.

### CROSS-REFERENCE TO RELATED APPLICATIONS

This utility patent application claims priority from U.S. provisional patent application Ser. No. 62/266,231, filed Dec. 11, 2015, titled “Replication of Components Through Geometric Element Matching” and naming inventors Malay Kumar and Abraham K. Feldman.

### COPYRIGHT NOTICE

A portion of the disclosure of this patent document contains material that is subject to copyright protection. The copyright owner has no objection to the facsimile reproduction by anyone of the patent document or the patent disclosure, as it appears in the Patent and Trademark Office patent file or records, but otherwise reserves all copyright rights whatsoever. Copyright 2016, Onshape, Inc.

### BACKGROUND

Field of Technology

This relates to Computer Aided Design (CAD) software, and more particularly to the replication of parts and assemblies within a CAD design.

Background

Computer Aided Design (CAD) software is a primary tool of mechanical and design engineers to create a complete representation of a final product to be fabricated. To complete the representation, component parts, subassemblies, and assemblies are created and connected such that the complete representation includes every occurrence of every component in the final product. Frequently, products include multiple occurrences of specific components, as a particular component may occur many times within an assembly (and often exists across multiple designs). Reusing components often requires specifying identical feature types, and repetitive placement of components and constraints is required to generate the complete representation along with a complete bill of materials needed for fabrication.

The increasingly growing market for CAD software has expanded to provide solutions where distributed design teams are often using different CAD software with many file types. Each file type may represent geometry, parts, and connections differently. Designers cannot rely on having particular parametric data associated with a particular component file even though current methods for reducing repetitive actions require providing parameters, existing parametric data, or accessing a specific database tracking prior use.

### DESCRIPTION OF PRIOR ART

United States Patent Application 2007/0174027 (“SYNCHRONIZED ARCHITECTURAL AND STRUCTURAL CAD MODELS” of Aleksey Moiseyev, published Jul. 26, 2007) disclose, in the Abstract, “Methods and apparatus, including computer program products, for providing an architectural computer aided design (CAD) model. A user input selecting an architectural element in the architectural CAD model is received. A structural element is automatically created in a structural CAD model, the structural element based on the selected architectural element. A monitored relationship is automatically established between the architectural element and the structural element.” This proposes a method for automatically creating a structural element based on user selection of an architectural element and establishing a monitored relationship between said elements. It also includes provisions for resolving violations of said relationships. This method focuses primarily on creating copies of singular relationships between architectural and structural elements and the collaborative opportunities provided by detailed management of said relationships.

U.S. Pat. No. 5,838,328 (“METHOD FOR GENERATING GRAPHICAL MODELS AND COMPUTER AIDED DESIGN SYSTEM” of Dieter Roller, issued Nov. 17, 1998) discloses, in the Abstract, “A computer aided design system generates graphical models of 2- or 3-dimensional objects with at least partially variable dimensions, in particular mechanical parts. In order to generate models having a predetermined plurality of structural elements, like through-holes, etc. being distributed over the model in a predetermined manner, the computer aided design system is provided with means for selecting a sub-group of design commands corresponding to a structural element of the model. After inputting a replication command, the selected element is replicated in a predetermined manner, e.g., distributed either by rotation about a predetermined center point at predetermined angular steps or shifted along linear axes with predetermined spacings or scaled at predetermined locations.” This describes a method for replicating a set of geometric elements corresponding to structural elements of an object based on user input parameters related to the group of elements. The scope includes replication of “geometric elements” or “design commands” where “geometric elements . . . comprises elementary geometric elements like dots, lines, circles, etc. as well as annotations like hatchings, alphanumeric symbols, words, surface quality symbols, etc.” This method is based on a set of user input parameters to define a number and layout of replicated geometric elements.

U.S. Pat. No. 8,645,107 (“AUTOMATIC COMPONENT INSERTION AND CONSTRAINT BASED ON PREVIOUS-USE DATA” of Mark G. Gibson et al., issued Feb. 4, 2014) discloses, in the Abstract, “Automatically adding constraints between entities in a subject computer-aided design (CAD) model of a real-world object includes storing information regarding CAD model entities and related constraints in a computer database in Which the CAD model entities belong to one or more components of the subject CAD model or other CAD models. The computer database is accessed to determine previously used constraints for at least one entity of a given component being added to the CAD model, and constraints are automatically added between at least one entity of the given component and another entity in the subject CAD model based on the previously used constraints.” This outlines a method for automatic insertion of constraints based on a component's prior use. This method identifies likely constraint types by searching for how the component was used in other models tracked in a computer database and choosing constraints based on frequency of said usage. This method can also “suggest additional components that are frequently used with the inserted component.”

None of the above provides a CAD solution which (1) automatically determines existing constraints of a selected component, (2) automatically searches the rest of a design to identify matching possibilities where the selected component can be identically constrained, (3) automatically calculates parameters needed, and (4) replicates the selected component multiple times within the same design. What is needed, therefore, is a solution that overcomes the above-mentioned limitations and that includes the features enumerated above.

### BRIEF SUMMARY

Disclosed is a method and system for determining the required number of components and replicating them during assembly construction in CAD software. Typical replication methods require a set of parameters to define a replication count and locations either within the assembly itself or via a set of parent features. The disclosed method ignores parametric requirements, and instead searches the three-dimensional (3D) geometry of components mated to a replication candidate directly for geometric elements that are identical to those on which the candidate is constrained. The system counts the number of identical geometric elements to determine the number of candidate instances to replicate, and then constrains one instance to each element with constraints equivalent to the constraints applying to the original candidate.

### Features and Advantages

The disclosed method calculates replication count by locating identical geometric elements within a user defined search scope. It does so without requiring parametric definitions of a replication count or parametric information stored in parent feature. The geometric element search scope can include multiple related or unrelated component instances within a design, and the method places replication candidate instances as many times as computationally calculated and constrains them to the located identical geometric elements.

### BRIEF DESCRIPTION OF THE DRAWINGS

In the drawings, closely related figures and items have the same number but different alphabetic suffixes. Processes, states, statuses, and databases are named for their respective functions.

FIG. 1 is a flowchart showing the full process.

FIG. 2 is a drawing of a fully assembled cylinder head containing many occurrences of unique parts and subassemblies.

FIG. 3 is a drawing of a valve cover from FIG. 2 where bolts and washers for mounting the cover may occur nineteen times and are mated to identical edges along the perimeter and through the interior of the valve cover.

FIG. 4 is a drawing of a crankshaft assembly with one piston subassembly constrained and three faces on the crankshaft that are without pistons and completely unrelated parametrically.

FIG. 5 is a drawing of the crankshaft of FIG. 4 fully assembled with the crankshaft assembly containing four pistons and a crankshaft.

### DETAILED DESCRIPTION, INCLUDING THE PREFERRED EMBODIMENT

In the following detailed description, reference is made to the accompanying drawings which form a part hereof, and in which are shown, by way of illustration, specific embodiments in which the invention may be practiced. It is to be understood that other embodiments may be used, and structural changes may be made without departing from the scope of the present disclosure.

### Terminology

The terminology and definitions of the prior art are not necessarily consistent with the terminology and definitions of the current disclosure. Where there is a conflict, the following definitions apply.

Instance: a single, specific realization of a component.

Component: a part or subassembly within a larger whole.

Occurrence: the realization of an instance within an assembly or subassembly.

Geometric element: an edge or face contained within a single component.

Seed: the initial selection of an instance as part of the replication process.

Scope: the selection or group of selections within which the system analyzes geometric elements.

Part: a single unique entity used within an assembly or sub-assembly.

Assembly: a group of components (parts and subassemblies) combined in a specific way to serve a particular function.

Subassembly: a smaller group of components assembled separately but designed to be incorporated into a larger assembly.

Replication: the action of reproducing a particular set of components in a specific manner.

Replication candidate: a component that fits the criteria for replication.

CAD: Computer aided design, a software system of record for the geometric representation of a design.

Constraint: a relationship between components limiting degrees of freedom.

Mate: the user-facing application of constraints between components.

Face: a topological representation of a bounded surface, where the boundary is formed by one or more edges.

Edge: a topological representation of a bounded curve.

### Operation

Computer aided design (CAD) operates as a dedicated software application running on a computer, or through a distributed model with a CAD software interface displaying on a computing device and communicating with one or more other computers executing CAD software computations. A CAD user interface device is used for a human user to interact with the CAD program. The CAD interface device includes an output display for rendering designs in progress and options for altering the design, and input controls to interact with the rendered display. Examples may include, but are not limited to, desktop computers, tablets, or mobile phones. The computing device operating the CAD software computations may be the same device as the interface device, or another separate computer or distributed computing solution connected over a network to the interface device. The CAD software computation device includes one or more processors, memory, and access to storage sufficient to compute and update changes to a design as manipulated by a user interacting with the CAD interface device.

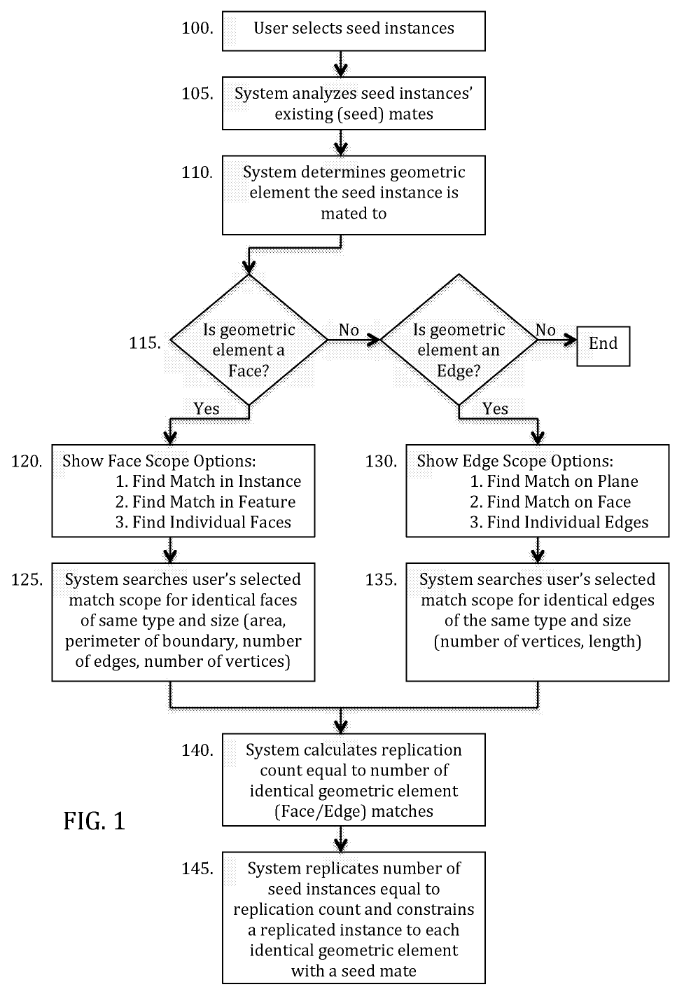

Within an operating CAD user interface, a user manipulates a design to create and/or constrain parts, sub-assemblies, and assemblies as normal operation of CAD. Referring to FIG. 1, to begin replication the user selects 100 a seed instance of one or more parts or subassemblies. Selection may be done through normal user interface controls, such as mouse, touch, or other pointer control to select components present in the design. Selection may be made by directly selecting specific components, or creating a region such as a square, box, or free-form area to select all components within the region. Alternatively, components may be selected through text such as in feature lists or other textual representations of the design. Selection may be expanded or reduced, such as using a control key to add or remove components from the seed instance selection. Seed selection may be made prior to, or after, selection of a replication tool or input of a command, such as a specific keyboard input or sequence, to trigger the replication process within the CAD program. Multiple seed instances may be selected.

The replication process may begin automatically if triggered after selection of seed instances, or automatically after selection of seed instances if triggered with no seed selected, or triggered after waiting for a specific command (such as activation of an “OK” or “Replicate” button with the user interface). Waiting for the specific command to begin is preferable to ensure proper selection of the seed instance. Once begun, the CAD computation system analyzes 105 mates through which the seed instance is constrained to identify geometry elements outside of the seed instance. Mates identify constraints between multiple components which affect positioning, connection, and possible movement. They may be represented and tracked within the CAD computation system in various ways, but in such a fashion that the system can identify all mates for each component, and identification of each mate also identifies two components connected by the mate along with all configured constraints.

By analyzing mates of the seed instance, the CAD computation system can identify the geometry of components mated to the seed instance. In most cases two components can be constrained using a single mate or geometry element controlling the connection between the components, so in some embodiments the replication tool may be limited to only replicate seed instances with a single mate.

By analyzing the mate, the CAD computation system determines 115 if the seed element is mated to an edge or a face. The CAD user interface presents choices to the user to identify a scope within which to replicate. If the matched mate geometric element is a face, the user may choose to find matching faces in selected instances, find matching faces in features, or find matching faces in individual faces. This choice may be presented 120 to the user through user interface interaction, such as a new pop-up box or within a dynamically updating section of a dialog box for control of the replication tool. To find matches within instances, the user may select one or more components within the design, and all faces of those instances will be searched. To find matches within features, the user may select one or more features within a feature list, and all faces of those features will be searched. To search individual faces, the user may select one or more faces within the design, and those faces will be searched. Faces have standard properties, including area, periphery, number of loops, number of edges, number of vertices, and surface type, which are tracked by the CAD computation system through objects or other data structures representing each face and associated properties. When searching for matching faces, the CAD computation system compares 125 all faces in the identified scope with the geometry of the face where the seed instance is mated. This compares type, area, periphery, number of edges, number of loops if any, and, if available, dimensions of analytical surfaces, such as, but not limited to, radius of a cylinder or sphere, and identifies all matching faces within the scope.

If the matched mate geometric element is an edge, the user may choose to find matching edges on a plane, find matching edges on a face, or find matching edges within individual edges. This choice may be presented 130 to the user through user interface interaction, such as a new pop-up box or within a dynamically updating section of a dialog box for control of the replication tool. To find matches on a plane, the user may select one or more planes within the design, and all edges on those planes will be searched. To find matches on a face, the user may select one or more faces within the design, and all edges of those faces will be searched. To search individual edges, the user may select one or more edges within the design, and those edges will be searched. Edges have standard properties, including length, number of vertices, and curve type, which are tracked by the CAD computation system via objects or other data structures representing each edge and associated properties. When searching for matching edges, the CAD computation system compares 135 all edges in the identified scope with the geometry of the edge where the seed instance is mated. This compares curve type, number of vertices, length, and, if available, dimensions of analytical curves such as, but not limited to, minor and major radius of an ellipse, and identifies all matching edges within the scope.

If the seed instance, or face or edge to which the seed is mated, falls within the search scope, the matching analysis ignores the seed instances and the face or edge to which they are mated to avoid exact duplication at the point of an existing element.

As the CAD computation system identifies matches within the search scope, it keeps 140 a count of all matches as a total replication count and retains references to each matched face or edge. The system next creates 145 new instances of all instances in the seed equal to the replication count, matching any size, type, or other configurable property with the properties in the seed instance. For each new copy of the seed, a new mate is created (one mate for each match found), with the mate linking the new copy and a found match with constraints equivalent to the constraints of the mate from the seed.

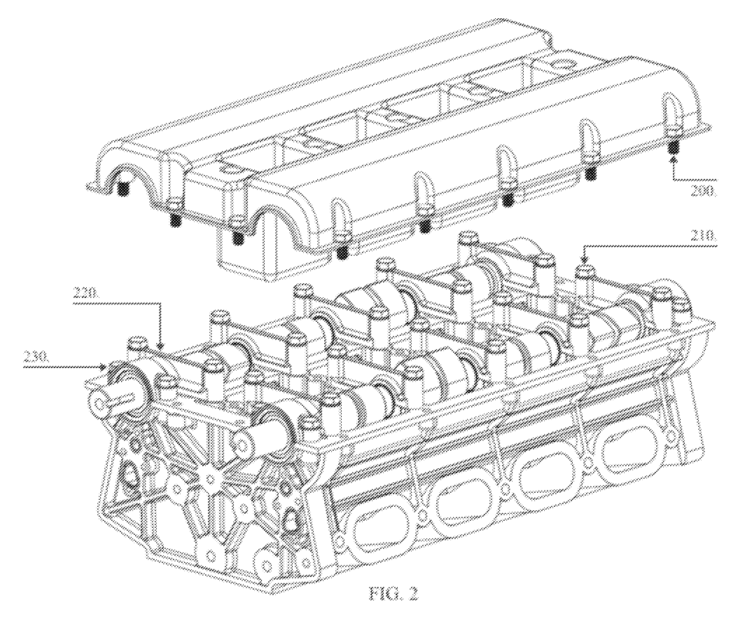

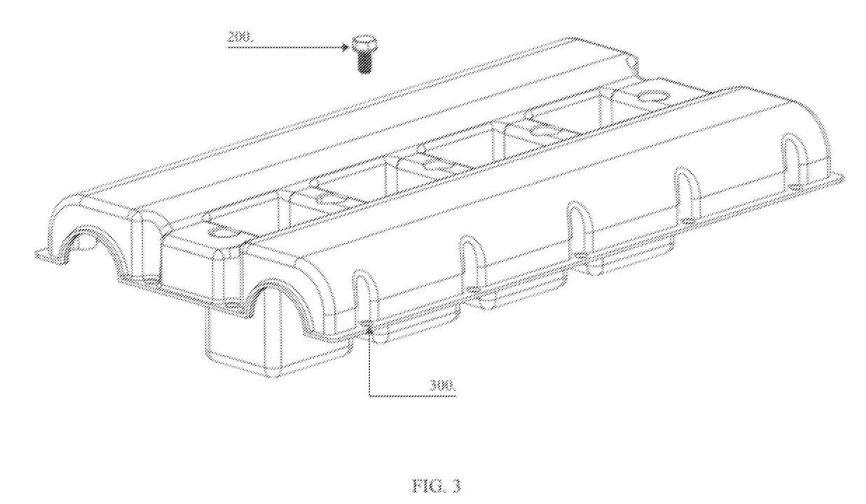

Referring also to FIGS. 2-3, an example CAD design may be for a cylinder head with valve cover. Traditional CAD design techniques may be used to create the cover. In this specific example, nineteen holes 300 have been designed for bolts 200 to attach the cover. These holes may be created manually, or through replication of a geometric shape (circular cutout) given a fixed distance, direction, and number of repetitions. In traditional CAD programs, nineteen instances of washers and nineteen instances of bolts need to be created and manually mated. Using the techniques described herein, a single instance of a washer and a single instance of a bolt may be created and mated to a first hole. In this scenario, the mate is to the edge of the hole. A user may then select the bolt and washer as a seed instance for replication, and select a scope of the plane running through the flat border of the cover. As long as all nineteen holes were created with the same size, all will match for replication, resulting in the creation of eighteen additional instances of bolts and washers, and mates to each of the remaining eighteen holes. The same replication techniques may be used for the different bolts and washers 210 fixing camshaft brackets to the cylinder head, as well as different types of repeating brackets 220 and 230.

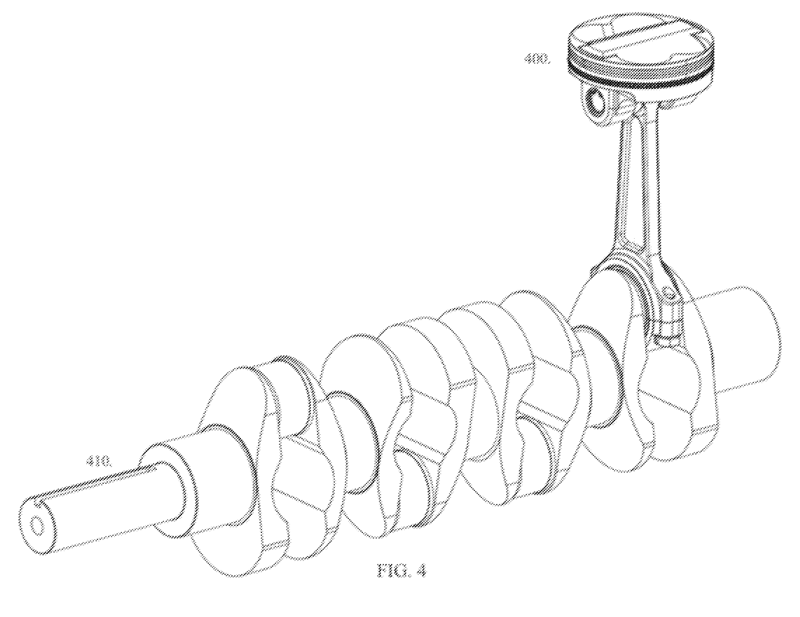

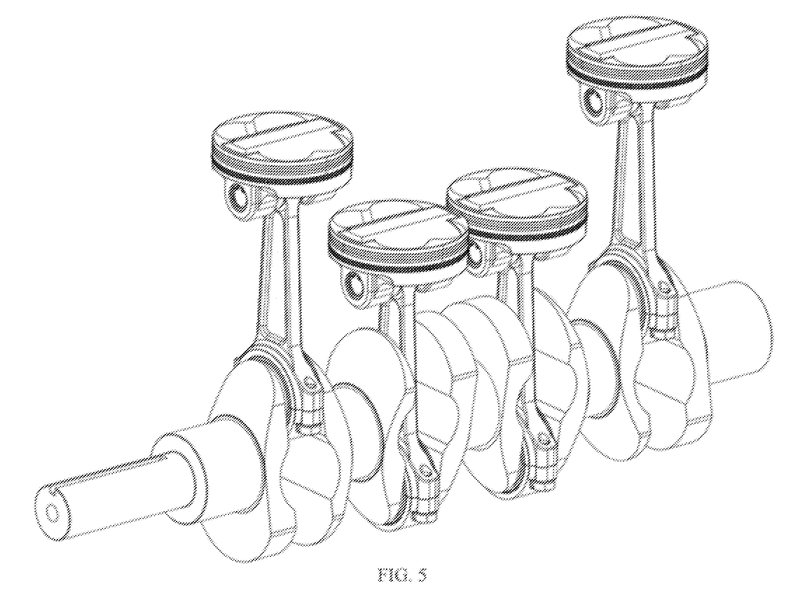

Referring also to FIG. 4, a complex piston subassembly may be mated to a first of multiple mounts on a crankshaft. The user may select piston subassembly 400 as the seed instance, and crankshaft instance 410 as the search scope. The mate of the piston to the crankshaft is identified, and (in this example) three additional matching faces exist (one in a matching “up” position and two in a “down” position but still having exact matching faces). With replication, three additional piston subassembly instances are created and mated to the three matching faces as shown in FIG. 5.

### Other Embodiments

An alternate embodiment may use mate connectors for replication. A mate connector is a defined reference within a design for positioning a mate between two instances and orienting those instances. Mate connectors may include metadata about location, orientation, and constraints on possible mates occurring at that mate connector. Replication may be performed by specifying a seed, identifying a mate connector at the mate to the seed, matching that mate connector with other mate connectors within a user-selected scope, and replicating the seed and constraining it at each matched mate connector. Using mate connectors for replication may also extend replication to instances which do not involve mating to a face or edge.

An alternate embodiment may expand scope matching to nest hierarchically, allowing scope and search to specify all matches within a sub-assembly or entire assembly.

An alternate embodiment may allow selection of a graphical region within a design, and setting scope to that entire graphical region.

An alternate embodiment may automatically perform or suggest replication automatically. When a user makes a new mate within a design, the system may automatically search the design for other identical matches as if the user initiated replication, and replicate or suggest replication for user confirmation based on matches. This alternate embodiment may be preferred with replication based on mate connectors, with replication automatically suggested based on identical connectors.

An alternate embodiment may track replication data within components, allowing automatic updating if additional matching elements are added. Each replicated instance may include replication metadata separate from any parametric relationship. A user may then re-run replication on any previously replicated instance, allowing for update of the replication count for modification in geometric element match or scope.

An alternate embodiment may replicate in situations where the selected seed has more than one mate. The same scope and match process is performed, except requiring matching of all mates. This may be performed by first identifying matches with a first mate, then of those matches identifying if a second mate is also matched, and continuing until all mates have been matched.

The methods and systems described herein may be implemented in hardware, software or any combination of hardware and software suitable for a particular application. The hardware may include a general purpose computer and/or dedicated computing device or specific computing device or particular aspect or component of a specific computing device, including mobile computing devices such as, but not limited to, cell phones, mobile phones, mobile personal digital assistants, laptops, palmtops, netbooks, or tablets. The processes may be realized in one or more micro-processors, micro-controllers, embedded micro-controllers, programmable digital signal processors or other programmable device, along with internal and/or external memory. The processes may also, or instead, be embodied in an application specific integrated circuit, a programmable gate array, programmable array logic, or any other device or combination of devices that may be configured to process electronic signals.

The methods and systems described herein may be deployed in part or in whole through network infrastructures. The network infrastructure may include elements such as, but not limited to, computing devices, servers, routers, hubs, firewalls, clients, personal computers, communication devices, routing devices and other active and passive devices, modules and/or other components. The computing and/or non-computing device(s) associated with the network infrastructure may include, apart from other components, a storage medium such as, but not limited to, flash memory, buffer, stack, RAM, or ROM.

The computer software described herein may be stored and/or accessed on machine readable media that may include: computer components, devices, and recording media that retain digital data used for computing for some interval of time; semiconductor storage known as random access memory (RAM); mass storage typically for more permanent storage, such as, but not limited to, solid state drives, optical discs, forms of magnetic storage like hard disks, tapes, drums, cards and other types; processor registers, cache memory, volatile memory, non-volatile memory; optical storage such as CD, DVD; removable media such as flash memory, floppy disks, magnetic tape, standalone RAM disks, removable mass storage, other computer memory such as, but not limited to, dynamic memory, static memory, read/write storage, mutable storage, read only, random access, sequential access, location addressable, file addressable, content addressable, network attached storage, or a storage area network.

It is to be understood that the above description is intended to be illustrative, and not restrictive. Many other embodiments will be apparent to those of skill in the art upon reviewing the above description. The scope of the invention should, therefore, be determined with reference to the appended claims, along with the full scope of equivalents to which such claims are entitled.

What is claimed is:

1. A method for replication within a parametric computer-aided design (CAD) program operating on a computer hardware system, comprising:
displaying, within a user interface of the CAD program, a design for editing;
selecting, by a user through user interface controls, a seed instance within the design;
determining, by the CAD program, geometry of one or more mated geometric elements having one or more mates to the seed instance;
identifying, by the CAD program, within a search scope, geometry of one or more unmated geometric elements having matching geometry with the geometry of the one or more mated geometric elements;
creating a new instance of the seed instance for each of the one or more matched unmated geometric elements; and
mating the new instances at each of the one or more matched unmated geometric elements with constraints equivalent to constraints of the one or more mates to the seed instance.

2. The method of claim 1, further comprising analyzing, by the CAD program, one or more mates of the seed instance to identify one or more components having the one or more mated geometric elements.

3. The method of claim 2, wherein analyzing the one or more mates further comprises determining if the one or more mates connect the seed instance to an edge or a face.

4. The method of claim 3, further comprising presenting one or more user interface options for selection of the search scope.

5. The method of claim 4, wherein the determined one or more mates connect the seed instance to a face, and wherein presenting further comprises allowing selection of finding faces in selected instances, finding faces in features, or finding faces within individual faces.

6. The method of claim 5, wherein identifying further comprises comparing geometric properties of faces within the search scope with geometric properties of the one or more mated geometric elements, wherein geometric properties include area, periphery, number of loops, number of edges, number of vertices, and surface type.

7. The method of claim 6, further comprising removing any faces connected to the seed instance by one or more mates from the search scope before comparing geometric properties of faces.

8. The method of claim 4, where the determined one or more mates connect the seed instance to an edge, and wherein presenting further comprises allowing selection of finding edges on a plane, finding edges on a face, or finding edges within individual edges.

9. The method of claim 8, wherein identifying further comprises comparing geometric properties of edges within the search scope with geometric properties of the one or more mated geometric elements, wherein geometric properties include length, number of vertices, and curve type.

10. The method of claim 9, further comprising removing any edges connected to the seed instance by one or more mates from the search scope before comparing geometric properties of edges.

11. A non-transitory computer-readable medium for replication within parametric computer-aided design (CAD), comprising instructions stored thereon, that when operated on a processor, perform steps comprising:
displaying a design within a user interface for editing the design;
receiving selection, by a user through user interface controls, of a seed instance within the design;
determining geometry of one or more mated geometric elements having one or more mates to the seed instance;
identifying, within a search scope, geometry of one or more unmated geometric elements having matching geometry with the geometry of the one or more mated geometric elements;
creating a new instance of the seed instance for each of the one or more matched unmated geometric elements;
mating the new instances at each of the one or more matched unmated geometric elements with constraints equivalent to constraints of the one or more mates to the seed instance; and
storing the design as updated with the mated new instances.

12. The non-transitory computer-readable medium claim 11, wherein the steps further comprise analyzing one or more mates of the seed instance to identify one or more components having the one or more mated geometric elements.

13. The non-transitory computer-readable medium of claim 12, wherein analyzing the one or more mates further comprises determining if the one or more mates connect the seed instance to an edge or a face.

14. The non-transitory computer-readable medium of claim 13, wherein the steps further comprise presenting one or more user interface options for selection of the search scope.

15. The non-transitory computer-readable medium of claim 14, wherein the determined one or more mates connect the seed instance to a face, and wherein presenting further comprises allowing selection of finding faces in selected instances, finding faces in features, or finding faces within individual faces.

16. The non-transitory computer-readable medium of claim 15, wherein identifying further comprises comparing geometric properties of faces within the search scope with geometric properties of the one or more mated geometric elements, wherein geometric properties include area, periphery, number of loops, number of edges, number of vertices, and surface type.

17. The non-transitory computer-readable medium of claim 16, wherein the steps further comprise removing any faces connected to the seed instance by one or more mates from the search scope before comparing geometric properties of faces.

18. The non-transitory computer-readable medium of claim 14, wherein the determined one or more mates connect the seed instance to an edge, and wherein presenting further comprises allowing selection of finding edges on a plane, finding edges on a face, or finding edges within individual edges.

19. The non-transitory computer-readable medium of claim 18, wherein identifying further comprises comparing geometric properties of edges within the search scope with geometric properties of the one or more mated geometric elements, wherein geometric properties include length, number of vertices, and curve type.

20. The non-transitory computer-readable medium of claim 19, wherein the steps further comprise removing any edges connected to the seed instance by one or more mates from the search scope before comparing geometric properties of edges.
